(19) United States
(12) Patent Application Publication
(10) Pub. No.: US 2010/0115609 A1
(43) Pub. Date: May 6, 2010

(54) DEVICE FOR ACCESSING MEDICAL INFORMATION

(75) Inventor: Perry Spence, St. Charles, MO (US)

Correspondence Address: AT&T Legal Department - WW, Patent Docketing Room 2A-207, One AT&T Way, Bedminster, NJ, 07921, US

(73) Assignee: AT&T Mobility II LLC, Atlanta, GA (US)

(21) Appl. No.: 12/263,997

(22) Filed: Nov. 3, 2008

(51) Int. Cl. G06F 21/00

(52) U.S. Cl. 726/19

(57) ABSTRACT

A device for accessing medical information provides an emergency responder and/or emergency personnel the ability to access medical information in an emergency situation. The device can be used to access an individual's medical records for display, storage, and/or manipulation of the information on the device. The device can access an individual's medical information directly from the individual's mobile device, via removable memory, a SIM card, a port on the device, or the like. Thus, if there is no wireless access to the individual's mobile device, or the mobile device is inoperable, medical information is still obtainable.

### BACKGROUND

Access to a person's medical information may be crucial for emergency treatment. For example, the first responder may need to be made aware of the victim's current medical conditions, medications that the victim is taking, allergies or other medical information important to an emergency medical personnel. A first responder on the scene of an accident may have limited access to an accident victim's medical information. An accident victim may not be able to speak or may be unconscious, and the first responder may not be able to communicate with the victim. Even if able to provide information, a patient or victim may not be aware of the implications of certain medical conditions they may have with respect to a procedure the first responder may want to perform or a or medication the first responder may want to administer to the victim, for example.

Bracelets and/or necklaces may be worn by an individual to identify certain types of medical issues, such as by listing the condition on the bracelet. However, the depth of, type of, access to, and updates to the information is limited on a bracelet or necklace. For example, if a user has recently started taking a certain medication, this is not dynamically updated on a bracelet or necklace.

### SUMMARY

An emergency responder medical device (ERMD) can be an access device that provides first responders and/or emergency personnel immediate access to dynamically updated medical information associated with an individual. The ERMD can be used to access the individual's medical records for display, storage, or manipulation of the information directly from the ERMD. In an example configuration, access to the individual's medical records is accessed via hardware and/or software from a user's mobile device. In another example configuration, access to the individual's medical records is provided via a network. In various embodiments, the ERMD is verified before being granted authorization to access the individual's medical records from a user's mobile device. For example, a user can subscribe to a network to update medical information stored on the user's mobile device and the ERMD can be recognized, via the network, as a verified device for access.

In an example embodiment, the ERMD is configured to store and/or read medical information on/from a user's mobile device, or the like. In an example configuration, the ERMD comprises a media reader for reading a storage media used by the user's mobile device. In another example configuration, the ERMD comprises a port or channel that is opened upon authorization of access to medical information.

The ERMD can be pre-authorized via hardware/software resident on the ERMD or via a network as an emergency responder. The user's mobile device can verify the emergency responder and/or the ERMD via identification of the ERMD directly or via information acquired from the network. For example, an ERMD may be pre-authorized by a network to access medical information, and store an indication of this on the ERMD. In this manner, when the ERMD or an emergency responder attempts to access the medical information from the user's mobile device, the verification of the ERMD or emergency responder may be based on the pre-authorized grant, previously acquired from the network. Thus, verification of the ERMD can be accomplished without a wireless connection or internet/network access. The components of each mobile device can be interconnected, thus providing a direct physical connection. As a result, if the ERMD and mobile device are not able to connect wirelessly, via a network, or some other intermediate access, the direct connection enables the ERMD to access the medical information.

### BRIEF DESCRIPTION OF THE DRAWINGS

The foregoing Summary, as well as the following Detailed Description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 depicts an example configuration of a system that includes an emergency responder medical device and a user's mobile device.

FIG. 2 depicts an example configuration of a system that includes an emergency responder medical device and a network for additional medical resources.

FIG. 3 depicts an example method of accessing medical information from a user's mobile device via an emergency responder medical device.

FIG. 4 depicts another example method of accessing medical information from a user's mobile device via an emergency responder medical device.

FIG. 5 is a block diagram of an example processor 558 which can be employed in any of the embodiments disclosed herein.

FIG. 6 illustrates an example alternate block diagram of an exemplary GSM/GPRS/IP multimedia network architecture in which medical information access techniques can be incorporated.

FIG. 7 depicts an example method of a computing system that can perform the disclosed techniques.

### DETAILED DESCRIPTION OF ILLUSTRATIVE EMBODIMENTS

An access device for accessing medical information, also referred to herein as an emergency responder medical device (ERMD), provides a secure and efficient way for a first responder or other appropriate person, to access medical information, particularly in an emergency situation and particularly in a situation in which there is no Internet access or wireless transmission capabilities. An emergency responder can use the ERMD that includes features that enable the device to gain access to medical information. The emergency responder can then access an individual's medical records for display, storage, or manipulation of the information directly from the ERMD. For example, the special access can be provided via specific hardware and or special software installed in/on the ERMD.

The user's mobile device that stores medical information can include a method of verifying the emergency responder or the ERMD as an authorized individual/device, such that the ERMD is recognized as a valid device for accessing medical records. The ERMD and/or emergency responder can be pre-authorized such that verification of the ERMD or emergency responder under emergency conditions can be accomplished without a wireless connection or internet access. Thus, the techniques disclosed may still be performed even if the ERMD, or access device, is not capable of communicating with the user's mobile device. Example scenarios of wireless inoperability are i) the need to access medical information in a location that is out of range of wireless capabilities ii) if the mobile device or access device may not have wireless capabilities, or iii) if the mobile device has been damaged during the emergency that causes the wireless capabilities to be inoperable (e.g., antenna is broken or mobile phone will not power on). Thus, if wireless capabilities are inoperable, prohibited, undesired, or the like, a pre-authorized grant to the device or associated emergency personnel can provide access to the medical information. The ERMD or the emergency responder can be pre-authorized via a network authorization.

The aspects summarized above can be embodied in various forms. The following description shows, by way of illustration, combinations and configurations in which the aspects can be practiced. It is understood that the described aspects and/or embodiments are merely examples. It is also understood that other aspects and/or embodiments can be utilized, and structural and functional modifications can be made, without departing from the scope of the present disclosure. For example, although some aspects herein relate to methods of authorization and/or verification of an ERMD or an emergency responder, it should be noted that authorization and verification can be based on any criteria established by a standards group, by the medical community, or the like. Similarly, although some aspects relate to example methods of reading/accessing medical information from a user's mobile device when a wireless connection is unavailable, it should be noted that any method that enables an ERMD to access medical information under such circumstances is contemplated.

Furthermore, in the discussion that follows, details relating to mobile devices and networks are assumed to be well known. Accordingly, such details are largely omitted herein for the sake of clarity and explanation. In addition, any references herein to an example embodiment involving a cell phone is solely for purposes of explanation, and is not intended to limit the techniques disclosed to any such embodiment. For example, a mobile device as contemplated by various embodiments of the techniques disclosed can include, but are not limited to: cellular telephones, personal digital assistants (PDAs), email devices and the like. The mobile device can operate in a cellular, SMR, PCS, cordless, unlicensed AWS, 700 MHz, or other spectrums. Furthermore, embodiments are not limited by the network servicing the device. Accordingly, embodiments can be applicable to any network type including, for example, TDMA, CDMA, WCDMA, GSM, WiFi, WiMAX, OFDM, UMTS, EV-DO, HSDPA/HSUPA and other standards now known or to be developed in the future.

Many of the functional units described in this specification have been labeled as modules, in order to more particularly emphasize their implementation independence. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network.

Reference throughout this specification to “one embodiment,” “an embodiment,” “an example embodiment,” or similar language means that a particular feature, structure, or characteristic described in connection with the embodiment is included in at least one embodiment of the present techniques disclosed. Thus, appearances of the phrases “in one embodiment,” “in an embodiment,” “an example embodiment,” and similar language throughout this specification may, but do not necessarily, all refer to the same embodiment.

Furthermore, the described features, structures, or characteristics of the disclosed techniques can be combined in any suitable manner in one or more embodiments. In the following description, numerous specific details are provided, such as examples of programming, software modules, user selections, network transactions, removable storage, storing medical information, etc., to provide a thorough understanding of embodiments of the disclosed techniques. One skilled in the relevant art will recognize, however, that the disclosed techniques can be practiced without one or more of the specific details, or with other methods, components, materials, and so forth. In other instances, well-known structures, materials, or operations are not shown or described in detail to avoid obscuring aspects of the disclosed techniques.

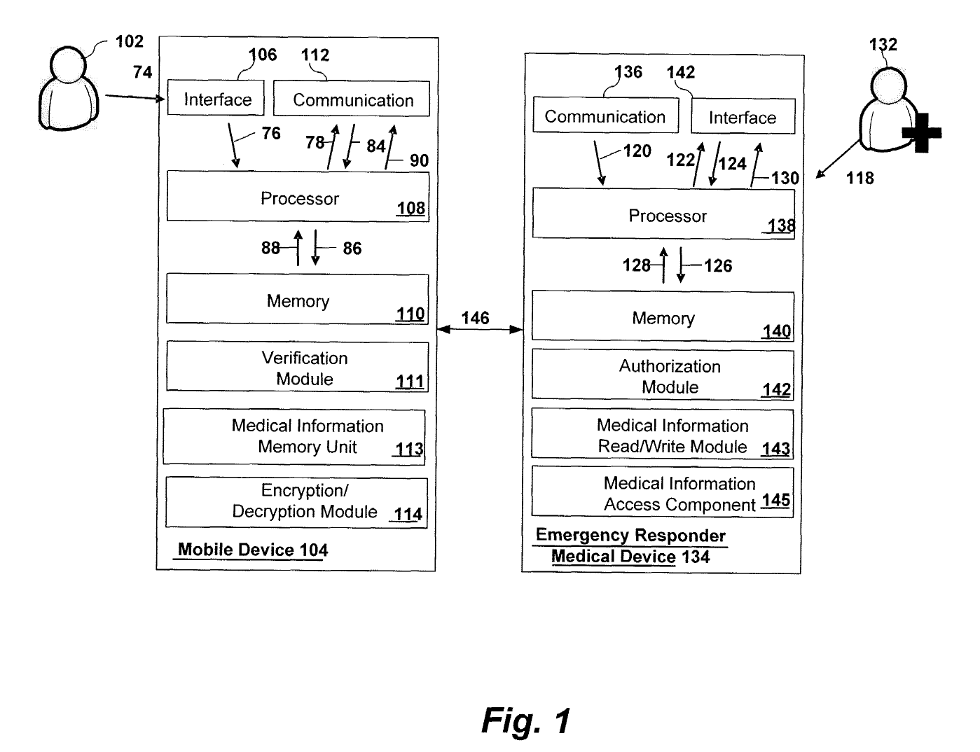

FIG. 1 depicts example system 100 and example processes for authorizing an ERMD 134 and using the ERMD 134 to access medical information from a mobile device. System 100 can include mobile device 104 and an ERMD 134.

The mobile device 104 can be representative of any appropriate type of mobile device, such as a cellular phone that a user typically carries on his or her person. The mobile device 104, as it is described herein, can include any mobile device that can be utilized, for example, to store medical information. According to example embodiments, the mobile device 104 can be, for example, a portable device, a variety of computing devices including (a) a portable media player, e.g., a portable music player, such as an MP3 player, a walkmans, etc., (b) a portable computing device, such as a laptop, a personal digital assistant (“PDA”), a portable phone, such as a cell phone of the like, a smart phone, a Session Initiation Protocol (SIP) phone, a video phone, a portable email device, a thin client, a portable gaming device, etc., (c) consumer electronic devices, such as TVs, DVD players, set top boxes, monitors, displays, etc., (d) a public computing device, such as a kiosk, an in-store music sampling device, an automated teller machine (ATM), a cash register, etc., (e) a navigation device whether portable or installed in-vehicle and/or (f) a non-conventional computing device, such as a kitchen appliance, a motor vehicle control (e.g., steering wheel), etc., or a combination thereof.

The mobile device 104 can include hardware components such as a processor, a graphics card, a storage component, a memory component, an antenna, a communication component, an interface component such as a speaker, a display, a keypad, a microphone, or the like, and a medical information access component 145. The mobile device 104 can also include software components such as an operating system that can control the hardware components.

In the embodiment shown in FIG. 1, the mobile device 104 includes an interface component 106, a processor 108, a memory component 110, a communication component 112, and a medical information memory unit 116. The interface component 106 can include, for example, an input/output portion such as a keypad, a touch screen, a button, a microphone, or the like, and an output component such as a speaker, a microphone, or the like. The medical information memory unit 113 can store the medical information. The medical information memory unit 113 can be a non-removable media, such as a computer chip installed in the mobile device 104, a removable media (e.g., a SIM card, a Secure Digital card, a flash drive, a USB drive, magnetic tape, floppy disk, a compact disc, or the like) or a removable drive such as a removable hard drive. As it is understood in the art, non-removable media refers to a component that is more permanent and not easily removed or intended to be removed by the consumer. However, many non-removable components can be removed from a device in some manner. The software components that can control the hardware components shown in this example embodiment are a verification module 111 and an encryption/decryption module 114.

According to one embodiment, at 74, a user 102 can interact with the mobile device 104 to, for example, make a phone call or update the medical information stored on the mobile device 104. For example, as described above, the interface component 106 can include an input component such as a keypad, a touch screen, a button, a microphone, or the like. At 74, the subscriber 102 can interact with the input component of the interface component 106 to power on the mobile device 104, input medical information in to the mobile device 104, access a network, or the like.

The user 102 can input medical information to the medical information memory unit 113 of the mobile device 104. For example, the user 102 can be a patient that can update the medical information on the medical information memory unit 113 on the patient's mobile device 104 directly via the interface component 106, such as via a display. The patient can update the medical information via the internet, etc., such as through the communication component 112. The communication component 112 can have input/output capabilities and include an antenna, communication port, or the like that can be used to establish a communication link with a network, for example. The communication component 112 can then communicate with servers or the like over the network to update, access, or store additional medical information.

The patient, such as user 102, can allow other individuals to have access to update, review, or modify the medical information, such as physicians, spouses, or the like. This allows healthcare providers, physicians, users, spouses, and the like, to record, store, and retrieve essential elements of medical encounters. Reference materials, diagnostic and treatment decisions, etc, can be included to facilitate care of the particular patient. In case of an emergency, for example, the user 102 can authorize a third party to locally access the medical information to display the information directly on a display component of the user's mobile device 104. The third party can select to display the information on the user's device, such as by pressing an access button on the user's mobile device 104 or entering a password provided by the user 102.

The user's mobile device 104 can include a verification module 111. The verification module 111 can authorize a third party or another device that the third party is using to attempt to access the medical information. In an example configuration, the verification module 111 may provide a permission indicator to any emergency responder medical device that is registered to a network, such that any emergency responder with access to the ERMD is eligible to access the user's medical information. An open access embodiment such as this would allow broad access to medical information by those in the medical community, with limited restrictions. In another example configuration, a secured access configuration, the permission indicator can be based on a recognition of a compatible removable storage or interconnection to the user's mobile device that is specific to the medical community and/or specific to particular ERMDs. In another secured access configuration, the access device may require a pre-authorized grant for access to medical information. For example, the device attempting access to the user's mobile device can be a pre-authorized device for use in emergency situations and require verification by the user's mobile device before the access device receives a permission indicator. The user's mobile device 104 can verify the emergency responder 132 or the ERMD 134 in a number of ways. For example, an emergency responder 132 can be pre-authorized via a network and the pre-authorized grant can be recognized by the verification module 111 of the user's mobile device 104 when the ERMD 134 attempts to access the medical information. Thus, upon the attempt to access medical information from a user's mobile device 104, the user's mobile device 104 can provide a permission indicator to the ERMD 134 based on the pre-authorized grant.

The ERMD 134 can receive the permission indicator directly from the mobile device, such as through a direct physical connection. For example, the ERMD 134 can receive the permission indicator via removable storage or an interconnection to the mobile device. As discussed above, the mobile device can include removable storage, non-removable storage, a removable hard drive, or the like. In an example embodiment, removable storage can be taken from the user's mobile device and be received by the ERMD 134, and the permission indicator can be provided via an interface between the ERMD 134 and the removable storage. The ERMD 134 can also receive the permission indicator directly via an interconnection to the mobile device. In an example configuration, the user's mobile device and the ERMD 134 have ports that can be connected via a wired connection. In another example configuration, a USB drive can be compatible with ports on both devices and transfer information between the devices.

The interface component 106 can provide a request for access by an ERMD 134 and/or associated with an emergency responder 132, for example, to the processor 108 at 76. The processor 108 can include any appropriate type of processor such as a single processor, multiple processors that can be distributed or centrally located, or the like. For example, the processor 108 can be a mobile communications device processor, a computer processor, a handheld processor, or the like. The processor 108 can include any other suitable hardware such as cache, Random Access Memory, storage devices, or the like and/or software. According to an example embodiment, if an ERMD 134 is verified, the processor 108 can activate a channel or a port on the user's mobile device 104 such that the ERMD 134 has access to the medical information on the medical information memory unit 113. For example, the channel or port can provide access to a hardware component that is activated specifically for an ERMD 134.

An encryption/decryption module 114 on the user's mobile device 104 can encrypt information written to the medical information memory unit 113 and decrypt the information to be read from the medical information memory unit 113. Likewise, the medical information can be encrypted for external access, and a second device with appropriate decryption module can decrypt the medical information. An access device, such as ERMD 134, can be one such second device.

According to an embodiment, at 118, an emergency responder 132 can interact with an ERMD 134 to, for example, attempt to access the medical information from the user's mobile device 104. The ERMD 134 can receive a permission indicator directly from the mobile device, such as through a direct physical connection, to access medical information that is on the user's mobile device 104. For example, a medical information access component 145 can be a port or receiving slot that provides a gateway for the emergency personnel to access the medical information on the user's mobile device 104 from the ERMD 134. The permission indicator can grant the ERMD 134 access to interconnect to the user's mobile device 104 or to receive and read a memory unit from the user's mobile device 104.

As described above, the interface component 106 can include an input component such as a keypad, a touch screen, a button, a microphone, or the like. The emergency responder 132 can interact with the input component of the interface component 106 to power on the mobile device 104, send instructions to the medical information access component 145, access a network, or the like. The emergency responder 132 can be any of a first responder, a certified first responder, a medically trained responder that is first to arrive on scene, an emergency medical professional, emergency medical technician, a policeman, a firefighter, or the like.

The ERMD 134 can be representative of any appropriate type of device that can be authorized for access to medical information that is stored on a user's mobile device 104. According to example embodiments, the ERMD 134 can be any appropriate mobile device that the emergency personnel can bring to the scene of an emergency. For example, the ERMD 134 can be any appropriate mobile device, such as, for example, a portable device or any of a variety of mobile devices (e.g., a portable media player, a portable music player, such as an MP3 player, a walkman, etc.), portable computing devices (e.g., a laptop, a personal digital assistant (“PDA”), a portable phone, such as a cell phone or the like, a smart phone, a Session Initiation Protocol (SIP) phone, a video phone, a portable email device, a thin client, a portable gaming device, etc.), or the like.

The ERMD 134 can include hardware components such as a processor, a graphics card, a storage component, a memory component, an antenna, a communication component, an interface component such as a speaker, a display, a keypad, a microphone, or the like, and a medical information access component 145. The ERMD 134 can also include software components such as an operating system that can control the hardware components.

In the embodiment shown in FIG. 1, the ERMD 134 is shown with an interface component 142, a processor 138, a memory component 140, a communication component 142, and a medical information access component 145. The software components that can control the hardware components shown in this example embodiment are an authorization module 142 and a medical information read/write module 143. The medical information read/write module 143 can further include an encryption/decryption module.

The mobile device 104 and ERMD 134 are depicted in FIG. 1 as being similar devices. A typical mobile device, such as mobile device 104, however, does not include modules to provide access to a third party's medical information. For example, a typical user's mobile device 104 does not receive a pre-authorized grant for access to medical information. Thus, any user 102 with a mobile device, such as 104, is not typically given authorization for access to a third party's medical information that is stored on the third party's mobile device. However, an emergency responder 132, for example, can opt to have their personal mobile device configured to become an ERMD 134, such as 134. In this way, the emergency responder 132 does not have to carry extra or special medical equipment for accessing medical information in the time of emergency. Thus, an emergency responder 132 can have access to a victim's medical information in an emergency situation simply by using their personal mobile device that has been configured as an ERMD 134.

A mobile device can be a personal mobile device that is configured as an ERMD 134 in a variety of ways. For example, a mobile device can become an ERMD 134 to be used by an emergency responder 132 if it is loaded with special medical information access software components, such as the authorization module 142 and the medical information read/write module 143. A mobile device can be an ERMD 134 if it includes specialized hardware that is compatible with the user's mobile device 104 or if it has a medical information access component 145 that is compatible with the memory unit 113 from the user's mobile device 104 for reading medical information. The ERMD 134 can be pre-authorized to read directly from the user's mobile device 104 or read from a memory unit 113 associated with the user's mobile device 104.

The ERMD 134 can include an authorization module 142. In one embodiment, the authentication module 142 ensures that only authorized persons can access the medical information from an ERMD 134. The authentication module 142 can require a secure login with an authorized password or the like to verify authorized use. In one embodiment, biometric information is verified before the user is authenticated. The biometric information can be provided by a biometric sensor, such as an external biometric sensor. In some embodiments, the authorization module 142 is used in conjunction with a standard login dialog associated with the operating system of the ERMD 134.

In certain embodiments, the authorization module 142 can essentially be a dedicated region of memory containing information that enables authorization. This information can be encrypted and match or correlate information provided by other means such as a bar code or biometric sensor. For example, an emergency responder could have a security stripe or bar code on an access card, and usage of the ERMD 134 could require the bar code scan to match encrypted information contained in the authorization module 142. The authorization module 142 can identify the emergency responder 132 accessing the ERMD 134 based on a password or security code, for example. In some embodiments, the authorization module 142 on the ERMD 134 includes a biometric sensor configured to verify biometric information of the emergency responder 132 utilizing the ERMD 134. In certain embodiments, the authorization module 142 includes a portion of the non-volatile memory containing authentication information, such as user names and passwords. Providing both physical and electronic sources of authentication information reduces the likelihood of tampering and information theft.

The interface component 106 can provide the request for access initiated by the emergency responder 132 to the processor 108 at 76. The processor 108 can include any appropriate type of processor such as a single processor, multiple processors that can be distributed or centrally located, or the like. For example, the processor 108 can be a mobile communications device processor, a computer processor, a handheld processor, or the like. The processor 108 can include any other suitable hardware such as cache, Random Access Memory, storage devices, or the like and/or software. The processor can determine whether the ERMD 134 is authorized to access medical information and, if so, access the information from the user's mobile device 104. For example, upon receipt of a permission indicator, the processor 108 can open a channel or port for access to the medical information on the medical information memory unit 113. The medical information can be accessed directly from the mobile device, such as via removable storage or an interconnection to the mobile device. The channel or port can be compatible with a channel or port that is opened on the user's mobile device 104 upon verification of the emergency responder 132 or ERMD 134. Thus, an open line of communication can be shared between the ERMD 134 and the user's mobile device 104.

The connection between the ERMD 134 and the mobile device 104 can be direct such that no wireless connection, internet access, or access to any other intermediate entity is necessary. For example, a first access component of a first mobile device 104, such as a user's or patients mobile device, can be interconnected to a second access component of a second device, such as an ERMD 134. The first and second access components can be hardware components that can interconnect. For example, the first access component can be a socket and the second access component can be a plug, wherein the socket can receive the plug. In another example, the first and second access components can both be plugs that can receive a wire that interconnects the two components.

Access to the medical information stored on the user's mobile device 104 can be a connection to read from a chip on the mobile device, the receipt of and read of a portable media (that can be moved between the user's mobile device 104 and the ERMD 134), or the like. The medical information can be stored on the user's mobile device 104 in a removable media, a non-removable media, a dedicated memory, or a general-purpose memory. Access can also be achieved by receiving the medical information over the connection between the devices, and storing the information on the ERMD 134 for access. Thus, the ERMD 134 can be setup with the ability to read information from SD, CF and Flash memory and comply with MESA guidelines. It is also understood that other aspects and/or embodiments can be utilized to interconnect the first mobile device to the second mobile device, and structural and functional modifications can be made, without departing from the scope of the present disclosure.

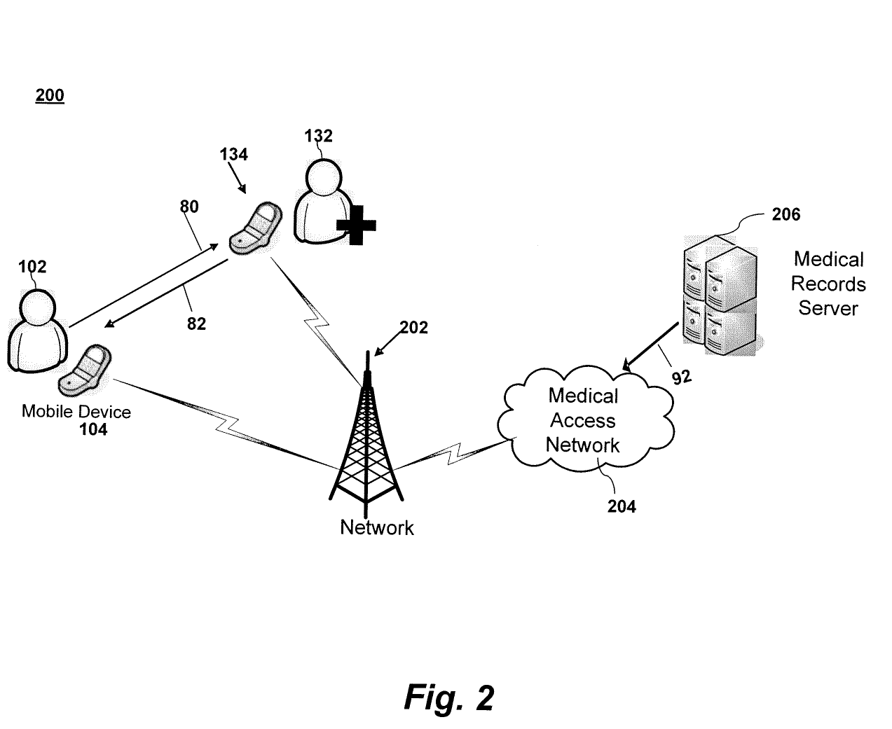

FIG. 2 depicts an example system 200 that can be utilized with the ERMD 134 disclosed herein. System 200 can include a user's mobile device 104, an ERMD 134, a network 150, a medical access network 204, and a medical records server 206.

A user 102 can interact with the mobile device 104 and an emergency responder 132 can interact with ERMD 134lnposelstartlnposelendlnposelstartlnposelend. In FIG. 2, both the mobile device and the ERMD 134 are depicted as a cellular telephone. The ERMD 134 can have special software/hardware, or network access components that authorize it or enable an emergency responder 132 to be authorized to access medical information from the user's mobile device 104.

The mobile device and the ERMD 134 can have access to network 150. The network can enable the user's mobile device 104 and the ERMD 134 to communicate with each other. For example, in certain circumstances, the ERMD 134 can be used to ping any user mobile devices that can be in the vicinity. The special purpose medical device can access information from a medical records server 122 via networks 150 and 120 (i.e., cellular network 150 can provide access to the medical access network 204).

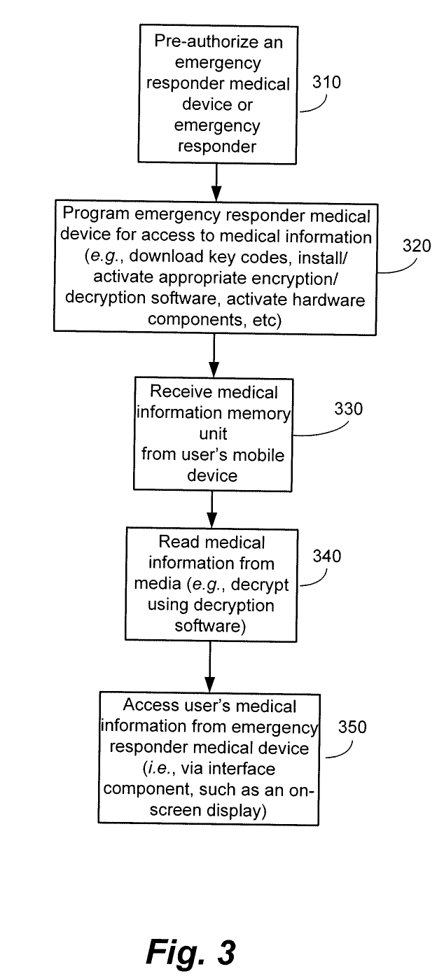

As shown in FIG. 1, a mobile device 104 can be in communication with a network 114. The network 114 can be any type of communication network such as the internet, a Local Area Network (LAN), a Wide Area Network (WAN), a cellular telephone network, or the like. For example, the network 114 can include the example networks described below in FIGS. 3-5 such as Global System for Mobile communication (“GSM”), General Packet Radio Service (“GPRS”), Universal Mobile Telephone System (“UMTS”), Frequency Division Duplexing (“FDD”) and Time Division Duplexing (“TDD”), High Speed Packet Data Access (“HERMDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), WiFi, WiMAX, or the like.

The mobile device and the ERMD 134, at 80 and 82, can interact with each other directly when there is no wireless connectivity. Thus, if a network is not available, such as due to inclement weather or an area without network coverage, the emergency responder 132 can still access the medical information from the user's mobile device 104. The emergency responder 132 can access the medical information from the users' mobile device via the ERMD 134. The emergency responder 132 can be pre-authorized as an emergency responder 132, and the user's mobile device 104 can include a verification module 111 to verify the emergency responder 132. Because of the authorization and verification procedures, the emergency responder 132 can have access to medical information that would be otherwise unavailable. For example, the medical information available to an emergency responder 132 via direct access from the user's mobile device 104, the information is typically limited due to privacy concerns, or requires user interaction to provide the necessary password information.

The network 202 can be operated by a network provider such as an internet service provider, a cellular telephone provider, or the like. According to an example embodiment, the network provider can offer bandwidth and/or network access to subscribers thereof to enable communication between the subscribers and other devices such as cellular phones, PDAs, PCs, Voice over Internet Protocol devices, analog telephone devices, or the like. In one embodiment, the bandwidth and/or network access provided by the network provider can be limited to a location 116 such as, for example, a country, a state, a city, a town, a county, or any other region defined by the network provider in which the network 114 can operate.

In the example system shown in FIG. 2, the medical access network 204 can provide a key code to subscribers or registered users/devices. For example, a user can subscribe to a network, such as the medical access network 204, that can authorize emergency responders and/or ERMDs. Likewise, an emergency responder 132 can register or subscribe to the medical access network 204, and ERMDs can be registered. The key code, such as a network identifier, a device identifier, a user identifier, or the like, can be an identification number or any other suitable alphanumeric representation that can be used to identify an entity. For example, the network identifier can be an identifier of the network to which there is a subscription, such as the medical access network 204. The network 114 can use the device identifier and/or the user identifier, along with the network identifiers, to determine, for example, whether an agreement exists between the user's mobile device 104 and the emergency responder 132's ERMD 134.

The network can assign a key code to a user when the user subscribes to the medical access network 204, or to an emergency responder 132 or ERMD 134 when they subscribe or are registered with the medical access network 204. For example, the network can assign a user identifier to the subscriber 102, an emergency responder 132 identifier to the emergency responder 132, and a device identifier to either or both of the user's mobile device 104 and the ERMD 134. The emergency responder 132 identifier can identify that the emergency responder 132 is registered with the medical access network 204 and/or has a subscription to such medical access network 204. Likewise, a network identifier can be an indication of a subscription or registration. The network 150 can provide appropriate key codes to the communication component 112 of the user's mobile device 104 and/or the ERMD 134 using the communication link established between the communication components, 112, 114 and the network 202.

In an example embodiment, the network 114 can determine whether the user's mobile device 104 or the ERMD 134 has permission to access the network 204 based on key codes associated with any of the user's mobile device 104, the ERMD 134, the emergency responder 132, or the like. For example, the network can verify an emergency responder 132 that attempts to register with the medical access network 204, such that, if a key code is assigned, it is assigned based on the requisite level of access within the bounds of current privacy laws. If the network determines that the emergency responder or the ERMD 134 is an authorized device, the network can pre-authorize the ERMD 134 as a verified medical device. For example, the ERMD 134 can be granted a key code that identifies the device as a verified medical device for accessing medical information.

When an emergency responder 132 uses the ERMD 134 to access the medical information from the user's mobile device 104, a correlating key code can be sufficient for authorizing the ERMD 134 for access. For example, the network can download the medical access network identifier to a subscribing user's mobile device 104 and/or to an ERMD 134 registered with the network. When an emergency responder 132 attempts to access medical information from the user's mobile device 104 via the ERMD 134, for example, the user's mobile device 104 can verify that the medical access network identifier correlates between the devices before opening a channel or port for access, and, upon verification, can provide a permission indicator to the ERMD 134.

A subscriber 102 can to opt to provide access to the subscriber 102's medical information only to select medical personnel and/or only to select information. Via the interface component 106 of the user's mobile device 104, the subscriber 102 can select the type and amount of medical information to be accessible via a third party device. The user can choose to make medical information accessible by select medical personnel. For example, the subscriber 102 can select to reveal currently prescribed medications or a diabetic condition to an emergency responder 132 at the scene of an accident, or select to give all medical history to a family physician, but then choose not give access to all medical history to an emergency responder 132 that the subscriber 102 had in past years. In this manner, the subscriber 102 can provide access to select medical information that can be relevant in the case of emergency treatment and keep other records private depending on the circumstances. The subscriber 102 may select to hide or otherwise prevent access to information other than the medical information on the user's mobile device 104. For example, the subscriber may opt to prevent access by an emergency responder or an ERMD to non-medical information on the user's mobile device, such as pictures, work-related information, phone contacts, or the like.

In one embodiment, the user can select the type of information and authorize certain medical personnel via the network. The pre-authorized grant may be in the form of a key code associated with the medical personnel, such as the emergency responder 132 identifier. The appropriate key codes can be downloaded and stored by the user's mobile device 104. Then, at the time of an emergency, if there is a correlation between the key codes in the user's device to that of the emergency responder 132 or the ERMDs, access can be provided to the medical information on the user's device.

The user can store medical information on the medical information memory unit 113 of the mobile device 104. According to an embodiment, at 118, an emergency responder 132 can interact with an ERMD 134 to, for example, access the medical information from the user's mobile device 104. The user's mobile device 104 can include a verification module 111 to authorize a third party or a third party's attempt to access the medical information from a second mobile device. The verification module 111 can verify a user/device, which can be a third party or a device other than the user's. As described above, an emergency responder 132 or a particular ERMD 134 can be verified in a number of ways. For example, an emergency responder 132 can be pre-authorized via a network and the pre-authorization can be recognized by the verification module 111 of the user's mobile device 104 when the ERMD 134 attempts to access the medical information. As a result, the user's mobile device 104, via a direct connection, can provide the ERMD 134 with a permission indicator such that the ERMD 134 can access the user's medical information.

When an ERMD 134 or an emergency responder 132 attempts to access the medical information on a user's mobile device 104, the verification module 111 on the user's mobile device 104 can verify the key code associated with the ERMD 134 or emergency responder 132. If the key code correlates with one that is stored on the user's mobile device 104 as a result of the network authorization, then the ERMD 134 and/or emergency responder 132 is verified. Thus, an emergency responder 132 can use an ERMD 134 to access the medical information from the mobile device. Depending on the level of authorization, the emergency responder 132 may have access to a subset of the medical information.

Because the ERMD 134 or emergency responder 132 can be pre-authorized, verification by a user's mobile device 104 can take place at the scene of an accident and no wireless connectivity or internet/network access is necessary. Thus, if the mobile device is damaged, such as in a car accident, and is inoperable in any way, the ERMD 134 can still access medical information without requiring wireless access to a network or to the user's mobile device 104. For example, the medical information memory unit 113 can be removable from the user's mobile device 104 and be received by the ERMD 134. The verification module 111 can be on this memory unit, and run a verification of the ERMD 134 or verify the emergency responder 132 that is using the ERMD 134 via their access or key code, for example.

In the example described above, the network can continuously update a subscribing user's mobile device 104, when there is connectivity, with codes for authorized users/devices. In an example embodiment, a server accessible via the network maintains the codes for the emergency responders and ERMDs. The server can be continuously updated as medical personnel working in the field changes.

Authorization and verification can be accomplished via a network, via a handshake between the mobile devices, based on the presence of particular hardware, via a module programmed into the ERMD 134 and/or user's mobile device 104, or the like. For example, authorization and verification of the emergency responder 132 or device can be based on specialized software or hardware integrated into either or both of the user's mobile device 104 and the emergency responder 132's ERMD 134. The presence of a particular piece of hardware that can be specific to the medical community can be sufficient, or the integration of encryption/decryption software that is compatible with an encryption/decryption module 114 on the user's mobile device 104 specific to accessing medical information can suffice for verification.

An encryption/decryption module 114 on the user's mobile device 104 can encrypt information written to the medical information memory unit 113 and decrypt the information to be read from the medical information memory unit 113. Likewise, the medical information can be encrypted for external access, and a second device with appropriate decryption module can decrypt the medical information. A ERMD 134, such as ERMD 134, can be one such second device.

The grant of authorization can be specific to a subscribing network, such that any users that subscribe to the network have the option to enable authorized user's the access to the medical information stored on the user's mobile device 104. Multiple networks can adopt a similar schema for providing authorization to emergency personnel. The user's mobile device 104, via the verification module 111, can be adapted to recognize an authorized emergency personnel via the interface between the ERMD 134 and the user's mobile device 104. This example embodiment is depicted in the flow chart in FIG. 3.

The medical access network 204 can include information associated with, for example, rules, regulations, settings such as requirements or criteria for an emergency responder 132 or ERMD 134 to be authorized for medical information access. For example, the network 114 can include an authorization configuration component 118. The authorization configuration system 118 can include any combination of hardware components such as processors, databases, storage drives, registers, cache, RAM memory chips, data buses, or the like and/or software components such as operating systems, database management applications, or the like. According to an example embodiment, the authorization configuration system 118 can be a network-based server that can provide information to a user's mobile device 104 that indicates verified emergency responders or ERMDs.

FIG. 3 represents a method of the techniques disclosed herein in an example embodiment. In this example embodiment, the emergency responder 132 or ERMD 134 is pre-authorized over a network and the pre-authorization is sufficient to give the ERMD 134 access to the medical information from the user's mobile device 104.

In this example, an ERMD 134 or emergency responder 132 is pre-authorized at 310 to have access to medical information stored on a user's mobile device 104. As described above, pre-authorization can occur in a variety of ways. For example, a network to which the emergency responder 132 or users subscribe can authorize emergency responders and assign them a key code, for example. A network can similarly authorize an ERMD 134 to be used in the field by emergency responders. Sometimes, both the emergency responder 132 and the ERMD 134 need to be pre-authorized to access medical information from a user's mobile device 104. The pre-authorization can also come from the presence of specialized software or hardware specific to the medical community. For example, the ERMD 134 can be have an encryption/decryption module that is compatible with the encryption/decryption module 114 used to encrypt medical information stored on a user's mobile device 104.

At 320, the ERMD 134 can receive a pre-authorized grant or be programmed for access to medical information. For example, the ERMD 134 can download a key code(s) that is associated with an authorized emergency responder 132 or assigned to the authorized ERMD 134. The ERMD 134 can receive encryption/decryption module that is compatible with the encryption/decryption module 114 used to encrypt medical information stored on a user's mobile device 104.

The ERMD 134 can receive and read from the medical information memory unit 113 removed from the user's mobile device 104 at 330 and 340. For example, the ERMD 134 can have a slot to receive an SD, flash drive, USB, or other removable media that contains the user's medical information. The ERMD 134 can interconnect to the mobile device to read the medical information. At 350, the ERMD 134 accesses the medical information from the medical information memory unit 113. Access can be a result of a particular program, such as decryption software, being installed on the ERMD 134, a channel or port being opened, or the like. For example, the medical information can be encrypted for external access, and the ERMD 134 can have the appropriate decryption module to access and read the medical information.

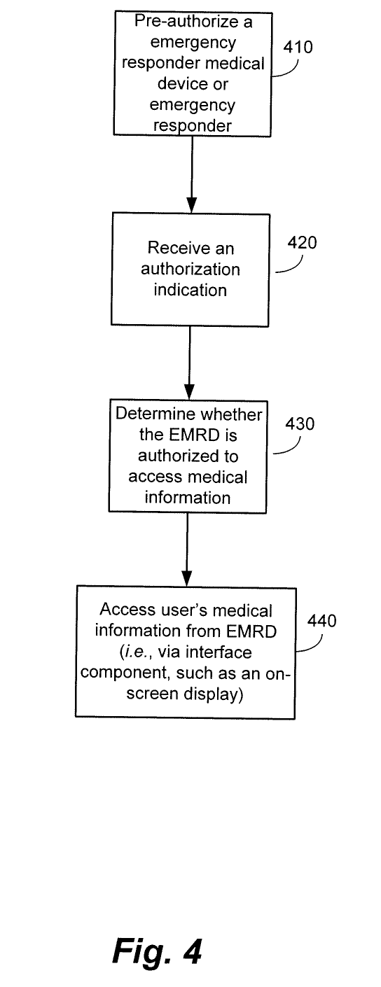

FIG. 4 represents another method of the techniques disclosed herein in an example embodiment. In this example embodiment, the ERMD 134 and the user's mobile device 104 are connected directly to each other. For example, both mobile devices can include hardware to allow the devices to be wired or otherwise directly connected.

At 410, the ERMD 134 or emergency responder 132 is pre-authorized to have access to medical information stored on a user's mobile device 104. As described above, pre-authorization can occur in a variety of ways. At 420, the ERMD 134 receives a permission indicator. The permission indicator can be received via a direct connection to the user's mobile device 104 or a portion thereof, such as via removable storage removed from the user's mobile device 104 and received by the ERMD 134 or a wired connection via respective medical access components, for example. The user's mobile device 104 can include a verification module 111 that verifies the ERMD 134 or the emergency responder 132 and provides the permission indicator to the ERMD 134. At 430, the ERMD 134, such as via a processing portion of the ERMD 134, can determine whether the ERMD 134 is authorized to access medical information. As described above, the permission indicator can be the based on the correlation of key codes. Likewise, the ERMD 134 and/or emergency responder 132 can be verified as a result of having been pre-authorized via the authorization module 142 on the ERMD 134.

If it is determined at 430 that the ERMD 134 is authorized to access medical information, the ERMD 134 can access the medical information from the user's mobile device 104. The access can be via a direct connection, such as by receiving and reading removable storage or interconnecting with the user's mobile device 104 to access internal memory on the user's mobile device 104. Access can be provided, for example, via a channel or port on the ERMD 134, opened by a processing module of the ERMD 134. The channel or port can be used to access medical information on the medical information memory unit 113 of the user's mobile device 104. The emergency responder 132 can then access the user's medical information from the ERMD 134, such as via a display.

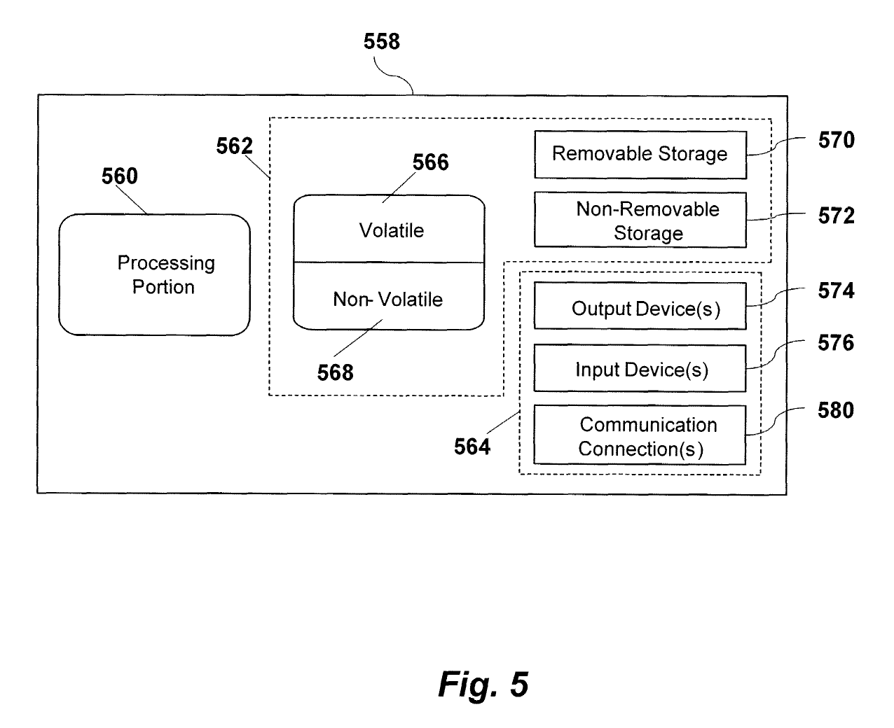

FIG. 5 is a block diagram of an example processor 558 which can be employed by the mobile device or access device in any of the embodiments described herein, including as one or more components of a communications device such as device 110, device 112, device 114, device 116, and/or wireless device 410, and/or as one or more components of communications network equipment or related equipment, such as ESME 142, ESC 140, GMLC 136, MSC 134, LMU 124, and/or SMLC 122. Processor 558 can also be one or more components within network 120. It is emphasized that the block diagram depicted in FIG. 5 is exemplary and not intended to imply a specific implementation. Thus, the processor 558 can be implemented in a single processor or multiple processors. Multiple processors can be distributed or centrally located. Multiple processors can communicate wirelessly, via hard wire, or a combination thereof.

The processor 558 comprises a processing portion 560, a memory portion 562, and an input/output portion 564. The processing portion 560, memory portion 562, and input/output portion 564 can be coupled together (coupling not shown in FIG. 5) to allow communications therebetween. The input/output portion 564 is capable of providing and/or receiving components utilized to detect activation of an emergency control, detect incoming emergency calls, determine if there are other contacts associated with an emergency call, and transmit and receive emergency and other communications. For example, the input/output portion 564 is capable of providing/receiving device 110 communications and location information, accepting/receiving requests for emergency services from device 110, transmitting/receiving requests for emergency services, processing requests for emergency services, and executing programs and applications related to the emergency services requests and the determination of devices or parties associated with a device transmitting an emergency services request, or any combination thereof, as described above.

In a basic configuration, the processor 558 can include at least one processing portion 560 and memory portion 562. The memory portion 562 can store any information utilized in conjunction with transmitting, receiving, and/or processing emergency services requests or medical information, determining whether there are associated contacts for a requesting device, and transmitting, receiving, and/or processing associated communications. For example, as described above, the memory portion is capable of storing key codes and applications and software to be compared against the key code of an ERMD 134. Depending upon the exact configuration and type of processor, the memory portion 562 can be volatile (such as RAM) 566, non-volatile (such as ROM, flash memory, etc.) 568, or a combination thereof. The processor 558 can have additional features/functionality. For example, the processor 558 can include additional storage (removable storage 570 and/or non-removable storage 572) including, but not limited to, magnetic or optical disks, tape, flash, smart cards or a combination thereof. Computer storage media, such as memory and storage elements 562, 570, 572, 566, and 568, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 558. Any such computer storage media can be part of the processor 558.

The processor 558 can also contain the communications connection(s) 580 that allow the processor 558 to communicate with other devices, for example through network 120. Communications connection(s) 580 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land-line telephone, and wireless media such as acoustic, RF, infrared, cellular, and other wireless media. The term computer readable media as used herein includes both storage media and communication media. The processor 558 also can have input device(s) 576 such as keyboard, keypad, mouse, pen, voice input device, touch input device, etc. Output device(s) 574 such as a display, speakers, printer, etc. also can be included.

The global system for mobile communication (GSM) is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signalling in an efficient manner. The GPRS attempts to optimize the use of network and radio resources, thus enabling the cost effective and efficient use of GSM network resources for packet mode applications.

As can be appreciated, the exemplary GSM/GPRS environment and services described herein also can be extended to 3G services, such as Universal Mobile Telephone System (UMTS), Frequency Division Duplexing (FDD) and Time Division Duplexing (TDD), High Speed Packet Data Access (HERMDA), cdma2000 1x Evolution Data Optimized (EVDO), Code Division Multiple Access-2000 (cdma2000 3x), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), etc., as well as to other network services that become available in time. In this regard, the techniques of receiving a pre-authorization grant and accessing the network can be performed independently of the method of data transport, and do not depend on any particular network architecture, or underlying protocols.

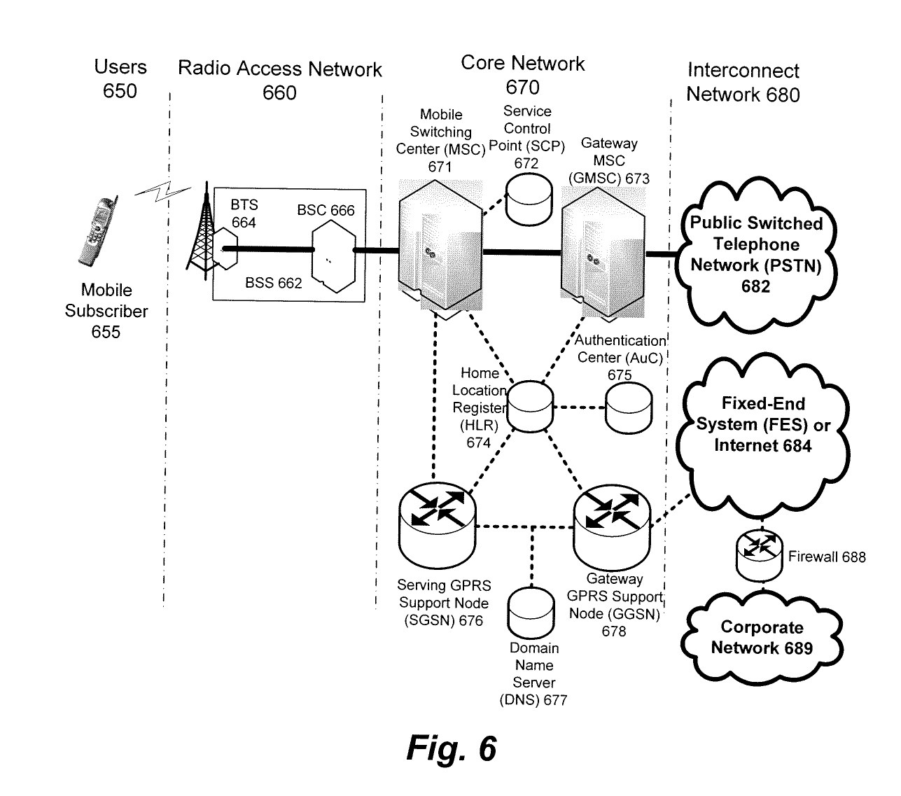

FIG. 6 illustrates an architecture of a typical GPRS network as segmented into four groups: users 650, radio access network 660, core network 670, and interconnect network 680. Users 650 comprise a plurality of end users (though only mobile subscriber 655 is shown in FIG. 6). In an example embodiment, the device depicted as mobile subscriber 655 comprises the WCD. Radio access network 660 comprises a plurality of base station subsystems such as BSSs 662, which include BTSs 664 and BSCs 666. Core network 670 comprises a host of various network elements. As illustrated in FIG. 6, core network 670 can comprise Mobile Switching Center (MSC) 671, Service Control Point (SCP) 672, gateway MSC 673, SGSN 676, Home Location Register (HLR) 674, Authentication Center (AuC) 675, Domain Name Server (DNS) 677, and GGSN 678. Interconnect network 680 also comprises a host of various networks and other network elements. As illustrated in FIG. 6, interconnect network 680 comprises Public Switched Telephone Network (PSTN) 682, Fixed-End System (FES) or Internet 684, firewall 688, and Corporate Network 689.

A mobile switching center can be connected to a large number of base station controllers. At MSC 671, for instance, depending on the type of traffic, the traffic can be separated in that voice can be sent to Public Switched Telephone Network (PSTN) 682 through Gateway MSC (GMSC) 673, and/or data can be sent to SGSN 676, which then sends the data traffic to GGSN 678 for further forwarding.

When MSC 671 receives call traffic, for example, from BSC 666, it sends a query to a database hosted by SCP 672. The SCP 672 processes the request and issues a response to MSC 671 so that it can continue call processing as appropriate.

The HLR 674 is a centralized database for users to register to the GPRS network. HLR 674 stores static information about the subscribers such as the International Mobile Subscriber Identity (IMSI), subscribed services, and a key for authenticating the subscriber 102. HLR 674 also stores dynamic subscriber 102 information such as the current location of the mobile subscriber. Associated with HLR 674 is AuC 675. AuC 675 is a database that contains the algorithms for authenticating subscribers and includes the associated keys for encryption to safeguard the user input for authentication.

In this disclosure, depending on context, the term mobile device user can be a subscriber 102, and either reference can sometimes refers to the end user and sometimes to the actual mobile device, such as the WCD 102, used by an end user of the mobile cellular service. When a mobile subscriber turns on his or her mobile device, the mobile device goes through an attach process by which the mobile device attaches to an SGSN of the GPRS network. In FIG. 6, when mobile subscriber 655 initiates the attach process by turning on the network capabilities of the mobile device, an attach request is sent by mobile subscriber 655 to SGSN 676. The SGSN 676 queries another SGSN, to which mobile subscriber 655 was attached before, for the identity of mobile subscriber 655. Upon receiving the identity of mobile subscriber 655 from the other SGSN, SGSN 676 requests more information from mobile subscriber 655. This information is used to authenticate mobile subscriber 655 to SGSN 676 by HLR 674. Once verified, SGSN 676 sends a location update to HLR 674 indicating the change of location to a new SGSN, in this case SGSN 676. HLR 674 notifies the old SGSN, to which mobile subscriber 655 was attached before, to cancel the location process for mobile subscriber 655. HLR 674 then notifies SGSN 676 that the location update has been performed. At this time, SGSN 676 sends an Attach Accept message to mobile subscriber 655, which in turn sends an Attach Complete message to SGSN 676.

After attaching itself with the network, mobile subscriber 655 then goes through the authentication process. In the authentication process, SGSN 676 sends the authentication information to HLR 674, which sends information back to SGSN 676 based on the user profile that was part of the user's initial setup. The SGSN 676 then sends a request for authentication and ciphering to mobile subscriber 655. The mobile subscriber 655 uses an algorithm to send the user identification (ID) and password to SGSN 676. The SGSN 676 uses the same algorithm and compares the result. If a match occurs, SGSN 676 authenticates mobile subscriber 655.

Next, the mobile subscriber 655 establishes a user session with the destination network, corporate network 689, by going through a Packet Data Protocol (PDP) activation process. Briefly, in the process, mobile subscriber 655 requests access to the Access Point Name (APN), for example, UPS.com (e.g., which can be corporate network 689 in FIG. 3) and SGSN 676 receives the activation request from mobile subscriber 655. SGSN 676 then initiates a Domain Name Service (DNS) query to learn which GGSN node has access to the UPS.com APN. The DNS query is sent to the DNS server within the core network 670, such as DNS 677, which is provisioned to map to one or more GGSN nodes in the core network 670. Based on the APN, the mapped GGSN 678 can access the requested corporate network 689. The SGSN 676 then sends to GGSN 678 a Create Packet Data Protocol (PDP) Context Request message that contains necessary information. The GGSN 678 sends a Create PDP Context Response message to SGSN 676, which then sends an Activate PDP Context Accept message to mobile subscriber 655.

Once activated, data packets of the call made by mobile subscriber 655 can then go through radio access network 660, core network 670, and interconnect network 680, in a particular fixed-end system or Internet 684 and firewall 688, to reach corporate network 689.

Thus, network elements can invoke the functionality of the access to a medical access network 204 for access to medical information via a ERMD 134, but they are not limited to Gateway GPRS Support Node tables, Fixed End System router tables, firewall systems, VPN tunnels, and any number of other network elements as required by the particular digital network.

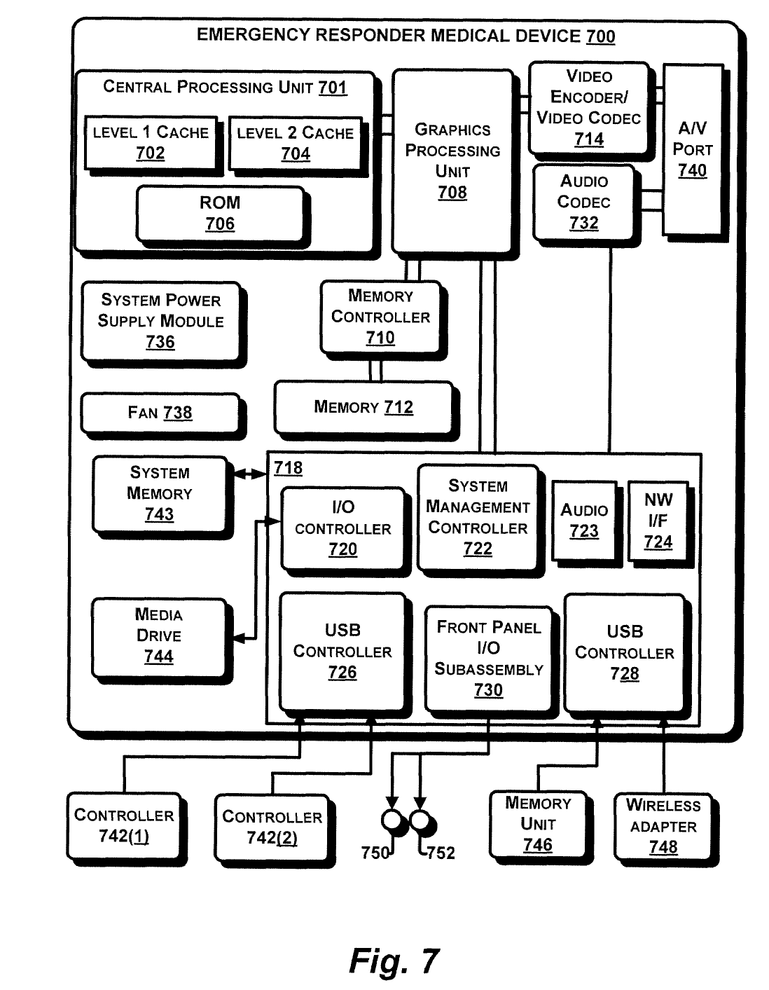

Referring now to FIG. 7, a block diagram shows an exemplary multimedia console. The emergency responder medical device 700 has a central processing unit (CPU) 701 having a level 1 (L1) cache 702, a level 2 (L2) cache 704, and a flash ROM (Read-only Memory) 706. The level 1 cache 702 and level 2 cache 704 temporarily store data and hence reduce the number of memory access cycles, thereby improving processing speed and throughput. The flash ROM 706 can store executable code that is loaded during an initial phase of a boot process when the ERMD 700 is powered. Alternatively, the executable code that is loaded during the initial boot phase can be stored in a flash memory device (not shown). Furthermore, ROM 706 can be located separate from CPU 701.

A graphics processing unit (GPU) 708 and a video encoder/video codec (coder/decoder) 714 form a video processing pipeline for high speed and high resolution graphics processing. Data is carried from the graphics processing unit 708 to the video encoder/video codec 714 via a bus. The video processing pipeline outputs data to an A/V (audio/video) port 740 for transmission to a television or other display. A memory controller 710 is connected to the GPU 708 and CPU 701 to facilitate processor access to various types of memory 712, such as, but not limited to, a RAM (Random Access Memory).

The ERMD 700 includes an I/O controller 720, a system management controller 722, an audio processing unit 723, a network interface controller 724, a first USB host controller 726, a second USB controller 728 and a front panel I/O subassembly 730 that are preferably implemented on a module 718. The USB controllers 726 and 728 serve as hosts for peripheral controllers 742(1)-142(2), a wireless adapter 748, and an external memory unit 746 (e.g., flash memory, external CD/DVD ROM drive, removable media, etc.). The network interface 724 and/or wireless adapter 748 provide access to a network (e.g., the Internet, home network, etc.) and can be any of a wide variety of various wired or wireless interface components including an Ethernet card, a modem, a Bluetooth module, a cable modem, and the like.

System memory 743 is provided to store application data that is loaded during the boot process. A media drive 744 is provided and can comprise a DVD/CD drive, hard drive, or other removable media drive, etc. The media drive 744 can be internal or external to the ERMD 700. Application data can be accessed via the media drive 744 for execution, playback, etc. by the ERMD 700. The media drive 744 is connected to the I/O controller 720 via a bus, such as a Serial ATA bus or other high speed connection (e.g., IEEE 1394).

The system management controller 722 provides a variety of service functions related to assuring availability of the ERMD 700. The audio processing unit 723 and an audio codec 732 form a corresponding audio processing pipeline with high fidelity, 3D, surround, and stereo audio processing according to aspects of the present disclosure described above. Audio data is carried between the audio processing unit 723 and the audio codec 726 via a communication link. The audio processing pipeline outputs data to the A/V port 740 for reproduction by an external audio player or device having audio capabilities.

The front panel I/O subassembly 730 supports the functionality of the power button 750 and the eject button 752, as well as any LEDs (light emitting diodes) or other indicators exposed on the outer surface of the ERMD 700. A system power supply module 736 provides power to the components of the ERMD 700. A fan 738 cools the circuitry within the ERMD 700.

The CPU 701, GPU 708, memory controller 710, and various other components within the ERMD 700 are interconnected via one or more buses, including serial and parallel buses, a memory bus, a peripheral bus, and a processor or local bus using any of a variety of bus architectures.

When the ERMD 700 is powered on or rebooted, application data can be loaded from the system memory 743 into memory 712 and/or caches 702, 704 and executed on the CPU 701. The application can present a graphical user interface that provides a consistent user experience when navigating to different media types available on the ERMD 700. In operation, applications and/or other media contained within the media drive 744 can be launched or played from the media drive 744 to provide additional functionalities to the ERMD 700.

The ERMD 700 can be operated as a standalone system by simply connecting the system to a television or other display. In this standalone mode, the ERMD 700 can allow one or more users to interact with the system, watch movies, listen to music, and the like. However, with the integration of broadband connectivity made available through the network interface 724 or the wireless adapter 748, the ERMD 700 can further be operated as a participant in a larger network community. In this latter scenario, the console 700 can be connected via a network to a server, for example.

While the disclosed techniques been described in connection with the preferred embodiments of the various figures, it is to be understood that other similar embodiments can be used or modifications and additions can be made to the described embodiment for performing the same function of the presently disclosed techniques without deviating therefrom. For example, while exemplary network environments of the disclosed techniques are described in the context of a networked environment, such as a peer to peer networked environment, one skilled in the art will recognize that the presently disclosed techniques are not limited thereto, and that the methods, as described in the present application can apply to any computing device or environment, such as a gaming console, handheld computer, portable computer, etc., whether wired or wireless, and can be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the presently disclosed techniques can be implemented in or across a plurality of processing chips or devices, and storage can similarly be effected across a plurality of devices. Therefore, the presently disclosed techniques should not be limited to any single embodiment, but rather should be construed in breadth and scope in accordance with the appended claims.

What is claimed:

1. An access device configured to access medical information, the access device comprising:
an input/output portion configured to:
receive a permission indicator directly via at least one of removable storage or an interconnection to a mobile device; and
receive the medical information directly via the at least one of removable storage or an interconnection to the mobile device;
a processing portion configured to:
determine, in accordance with the received permission indicator, whether the access device is authorized to access the medical information; and
if the processing portion determines that the access device is authorized to access the medical information, access the medical information from the mobile device directly via the at least one of removable storage or an interconnection to the mobile device.

2. The access device in accordance with claim 1, wherein the access device is configured to receive a pre-authorized grant for accessing the medical information, wherein the pre-authorized grant is compared with the permission indicator to determine if the access device is authorized.

3. The access device in accordance with claim 2, wherein the permission indicator is based on the pre-authorized grant.

4. The access device in accordance with claim 2, wherein the pre-authorized grant is based on a subscription to a network.

5. The access device in accordance with claim 1, wherein the removable storage comprises a subscriber identity module (SIM).

6. The access device in accordance with claim 1, wherein the access device is not capable of wirelessly communicating with the mobile device.

7. The access device in accordance with claim 6, wherein the access device is not capable of wirelessly communicating with the mobile device due to at least one of damage to the mobile device, a lack of wireless capability of at least one of the access device or the mobile device, or a lack of reception in a location of at least one of the access device or the mobile device.

8. The access device in accordance with claim 1, wherein the processing portion comprises an encryption/decryption module for encrypting or decrypting the medical information.

9. A computer readable storage medium having stored thereon instructions for operating an access device for accessing medical information, wherein when the instructions are executed by the access device, the instructions cause the access device to perform a method comprising:
receiving a permission indicator directly via at least one of removable storage or an interconnection to a mobile device;
determining, in accordance with the received permission indicator, whether the access device is authorized to access the medical information; and
accessing the medical information, from the mobile device, wherein the medical information is accessed directly via the at least one of removable storage or an interconnection to the mobile device if the access device is authorized to access the medical information.

10. The computer readable storage medium in accordance with claim 9, wherein the permission indicator is based on a pre-authorized grant for accessing the medical information, wherein the pre-authorized grant is compared with the permission indicator to determine if the access device is authorized.

11. The computer readable storage medium in accordance with claim 10, the instructions further for process a pre-authorized grant provided via a network.

12. The computer readable storage medium in accordance with claim 10, wherein the pre-authorized grant is provided via a subscription to a network.

13. The computer readable storage medium in accordance with claim 9, wherein the removable storage comprises a subscriber identity module (SIM).

14. The computer readable storage medium in accordance with claim 9, wherein the access device is not capable of wirelessly communicating with the mobile device.

15. The computer readable storage medium in accordance with claim 14, wherein the access device is not capable of wirelessly communicating with the mobile device due to at least one of damage to the mobile device, a lack of wireless capability of at least one of the access device or the mobile device, or a lack of reception in a location of at least one of the access device or the mobile device.

16. The computer readable storage medium in accordance with claim 9, further comprising instructions for at least one of encrypting or decrypting the medical information.

17. A method for accessing medical information in an emergency situation, the method comprising:
receiving a permission indicator directly via at least one of removable storage or an interconnection to a mobile device;
determining, in accordance with the received permission indicator, whether an access device is authorized to access the medical information; and
accessing the medical information, from the mobile device, wherein the medical information is accessed directly via the at least one of removable storage or an interconnection to the mobile device if the access device is authorized to access the medical information.

18. The method in accordance with claim 17, further comprising receiving a pre-authorized grant for accessing the medical information, wherein the pre-authorized grant is compared with the permission indicator to determine if the access device is authorized.

19. The method in accordance with claim 18, wherein the permission indicator is based on the pre-authorized grant.

20. The method in accordance with claim 18, wherein the pre-authorized grant is based on a subscription to a network.

21. The method in accordance with claim 17, wherein the removable storage comprises a subscriber identity module (SIM).

22. The method in accordance with claim 17, wherein the access device is not capable of wirelessly communicating with the mobile device.

23. The method in accordance with claim 22, wherein the access device is not capable of wirelessly communicating with the mobile device due to at least one of damage to the mobile device, a lack of wireless capability of at least one of the access device or the mobile device, or a lack of reception in a location of at least one of the access device or the mobile device.

24. The method in accordance with claim 17, further comprising at least one of encrypting or decrypting the medical information.
